(19) United States
(12) Patent Application Publication
(10) Pub. No.: US 2006/0017717 A1
(43) Pub. Date: Jan. 26, 2006

(54) Controlling apparatus and method, recording medium, program, and inputting/outputting apparatus

(76) Inventor: Mitsuru Tateuchi, Kanagawa (JP)

Correspondence Address: JAY H. MAIOLI;Cooper & Dunham LLP, 1185 Avenue of the Americas, New York, NY, 10036, US

(21) Appl. No.: 11/182,409

(22) Filed: Jul. 15, 2005

(30) Foreign Application Priority Data
Jul. 21, 2004 (JP) P2004-212986

(51) Int. Cl. G09G 5/00

(52) U.S. Cl. 345/204

(57) ABSTRACT

An apparatus and method wherein a high detection sensitivity to light irradiated from the outside can be assured, in which each pixel of an I/O display apparatus can perform a light emitting action for displaying an image and a light receiving action for detecting light irradiated from the outside. In the light emitting action, a switch is switched on to cause an electroluminesence element to emit light. In the light receiving action, the switch is switched off so that charge generated by the electroluminesence element in response to reception of light from the outside is accumulated into a parasitic capacitor. This state is maintained for a predetermined period of time, within which all charge generated by the electroluminesence element is accumulated into the parasitic capacitor. After the period of time, the charge in the parasitic capacitor is extracted to detect the input light from the outside.

### BACKGROUND OF THE INVENTION

This invention relates to a controlling apparatus and method, a recording medium, a program and an inputting/outputting apparatus, and more particularly to a controlling apparatus and method, a recording medium, a program and an inputting/outputting apparatus which involve detection of light irradiated from the outside.

In recent years, various apparatus have been proposed which can input various kinds of information directly to a display apparatus without providing a touch panel or a like apparatus in an overlapping relationship. An apparatus of the type described is disclosed, for example, in Japanese Patent Laid-Open No. Hei 11-53111 (hereinafter referred to as Patent Document 1) or Japanese Patent Laid-Open No. 2004-127272 (hereinafter referred to as Patent Document 2).

For example, Patent Document 2 discloses a display apparatus wherein the voltage to be applied to each pixel is controlled to cause the pixel to execute a light emitting action for causing the pixel to emit light so that an image is displayed and a light receiving action of detecting light to the pixel from the outside. In the display apparatus, in the light receiving action, a voltage in a direction opposite to that in the light emitting action is applied to each pixel, and leak current generated in a pixel when light is irradiated upon the pixel while such a voltage in the opposite direction as just mentioned is applied to the pixel is used to detect light from the outside. Consequently, a user can directly input predetermined data to the display apparatus by irradiating light representing such data upon the display apparatus.

Also different apparatus have been proposed which perform a predetermined action in response to light from the outside. One of the apparatus of the type described is disclosed in Japanese Patent Laid-Open No. 2003-173876 (hereinafter referred to as Patent Document 3) which is formed as a light emitting display element which uses a film having a light responding property and emits displaying light in response to an input of light to the film. Another apparatus of the type described is disclosed in Japanese Patent Laid-Open No. Hei 9-282078 (hereinafter referred to as Patent Document 4) wherein striped electrodes are disposed perpendicularly to each other and a layer of amorphous silicon is interposed at intersecting points of and between the electrodes to dispose a photocell at each of the intersecting points.

Further, an apparatus is disclosed in Japanese Patent Laid-Open No. Hei 7-175420 (hereinafter referred to as Patent Document 5) wherein information inputted in the form of light is detected by an organic EL (electroluminescence) element serving as a light emitting element.

### SUMMARY OF THE INVENTION

Incidentally, in an apparatus of the type wherein leak current generated in a pixel is used to detect whether or not there exits light from the outside like, for example, the display apparatus disclosed in Patent Document 2, the detection sensitivity depends upon the amount (energy) of light irradiated upon pixels included in a unit area.

In particular, if a sufficient amount of light is irradiated, then a sufficient amount of leak current is generated in response the light, which provides high detection sensitivity. However, if a small amount of light is irradiated, then a small amount of leak current is generated in response to the light, which provides low detection sensitivity.

Since the detection sensitivity depends upon the amount of irradiated light in this manner, although there is no problem where the amount of light is large, conversely where the amount of irradiated light is small, there is the possibility that disadvantageously the input from the outside may not be detected correctly.

This commonly applies also to the other elements and apparatus disclosed in the other documents which perform a predetermined action in response to an input of light from the outside.

It is an object of the present invention to provide a controlling apparatus and method, a recording medium, a program and an inputting/outputting apparatus wherein high detection sensitivity to light irradiated from the outside can be assured.

In order to attain the object described above, according to an embodiment of the present invention, there is provided a controlling apparatus for controlling an inputting/outputting apparatus of the active matrix driving type which includes a pixel including an element whose action can be changed over between a light emitting action and a light receiving action in response to a voltage applied to the element, including an accumulation control section for causing charge generated by the element included in the pixel during the light receiving action in response to reception of light from the outside to be accumulated for a predetermined period of time, and a detection section for detecting an input of the light from the outside to the inputting/outputting apparatus based on the charge accumulated by the accumulation control section.

According to another embodiment of the present invention, there is provided a controlling method for a controlling apparatus for controlling an inputting/outputting apparatus of the active matrix driving type which includes a pixel including an element whose action can be changed over between a light emitting action and a light receiving action in response to a voltage applied to the element, including the steps of controlling accumulation of causing charge generated by the element included in the pixel during the light receiving action in response to reception of light from the outside to be accumulated for a predetermined period of time, and a detecting an input of the light from the outside to the inputting/outputting apparatus based on the charge accumulated by the processing of the accumulation control step.

According to a further embodiment of the present invention, there is provided a recording medium on which a program for causing a computer to execute a controlling processing for a controlling apparatus for an inputting/outputting apparatus of the active matrix driving type which includes a pixel including an element whose action can be changed over between a light emitting action and a light receiving action in response to a voltage applied to the element is recorded, the program including the steps of controlling accumulation of causing charge generated by the element included in the pixel during the light receiving action in response to reception of light from the outside to be accumulated for a predetermined period of time, and detecting an input of the light from the outside to the inputting/outputting apparatus based on the charge accumulated by the processing of the accumulation control step.

According to a still further embodiment of the present invention, there is provided a program for causing a computer to execute a controlling processing for a controlling apparatus for an inputting/outputting apparatus of the active matrix driving type which includes a pixel including an element whose action can be changed over between a light emitting action and a light receiving action in response to a voltage applied to the element is recorded, the program including the steps of controlling accumulation of causing charge generated by the element included in the pixel during the light receiving action in response to reception of light from the outside to be accumulated for a predetermined period of time, and detecting an input of the light from the outside to the inputting/outputting apparatus based on the charge accumulated by the processing of the accumulation control step.

With the controlling apparatus and method, recording medium and program, charge generated by an element included in a pixel during a light receiving action in response to reception of light from the outside is accumulated for predetermined period of time. Then, an input of the light from the outside to the inputting/outputting apparatus is detected based on the accumulated charge.

According to a yet further embodiment of the present invention, there is provided an inputting/outputting apparatus of the active matrix driving type which includes a pixel including an element whose action can be changed over between a light emitting action and a light receiving action in response to a voltage applied to the element, the pixel including an accumulation section for accumulating charge generated by the element included in the pixel upon the light receiving action in response to reception of light from the outside for a predetermined period of time under the control of a controlling apparatus, and an outputting section for outputting the charge accumulated in the accumulation section to the controlling apparatus.

With the inputting/outputting apparatus, charge generated by the element included in the pixel upon the light receiving action in response to reception of light from the outside is accumulated for a predetermined period of time under the control of the controlling apparatus. The accumulated charge is outputted to the controlling apparatus.

With the controlling apparatus and method, recording medium, program and inputting/outputting apparatus, light from the outside can be detected.

With the controlling apparatus and method, recording medium, program and inputting/outputting apparatus, high detection sensitivity to light irradiated from the outside can be assured.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a schematic view showing an example of an appearance of an I/O display apparatus to which the present invention is applied;

FIG. 2 is a diagrammatic view illustrating an output function of the I/O display apparatus;

FIG. 3 is a similar view but illustrating an input function of the I/O display apparatus;

FIG. 4 is a diagram illustrating an example of a current characteristic of a pixel shown in FIGS. 2 and 3;

FIG. 5 is a diagram showing, in an enlarged scale, a portion of the current characteristic of FIG. 4 around 0 V;

FIGS. 6 and 7 are circuit diagrams illustrating different actions of a circuit provided in a pixel;

FIG. 8 is a circuit diagram showing a particular example of the circuit;

FIGS. 9 through 12 are circuit diagrams illustrating different actions of the particular circuit;

FIG. 13 is a block diagram showing an example of a configuration of a controlling apparatus;

FIG. 14 is a block diagram illustrating an example of a functional configuration of the controlling apparatus;

FIG. 15 is a flow chart illustrating a controlling processing of the controlling apparatus;

FIGS. 16, 17 and 18 are block diagrams showing different particular examples of the circuit; and

FIG. 19 is a block diagram showing another different particular example of the circuit.

### DETAILED DESCRIPTION OF THE PREFERRED EMBODIMENT

Before a preferred embodiment of the present invention is described in detail, a corresponding relationship between several features recited in the accompanying claims and particular elements of the preferred embodiment described below is described. The description, however, is merely for the confirmation that the particular elements which support the invention as recited in the claims are disclosed in the description of the embodiment of the present invention. Accordingly, even if some particular element which is recited in description of the embodiment is not recited as one of the features in the following description, this does not signify that the particular element does not correspond to the feature. On the contrary, even if some particular element is recited as an element corresponding to one of the features, this does not signify that the element does not correspond to any other feature than the element.

Further, the following description does not signify that the prevent invention corresponding to particular elements described in the embodiment of the present invention is all described in the claims. In other words, the following description does not deny the presence of an invention which corresponds to a particular element described in the description of the embodiment of the present invention but is not recited in the claims, that is, the description does not deny the presence of an invention which may be filed for patent in a divisional patent application or may be additionally included into the present patent application as a result of later amendment to the claims.

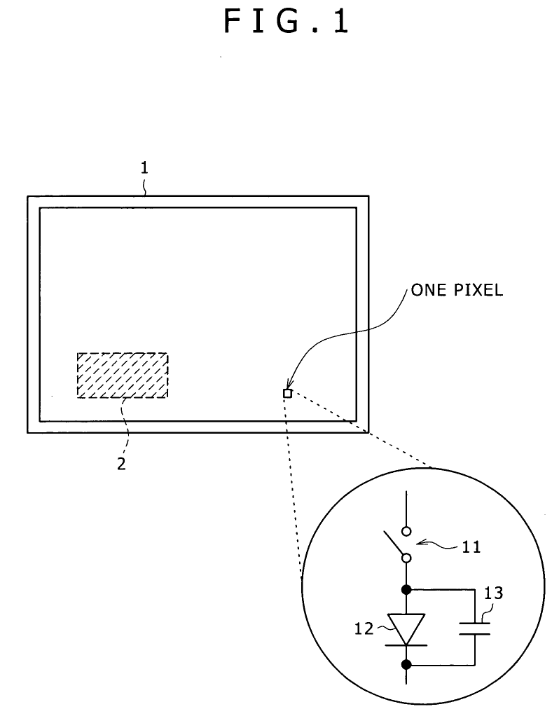

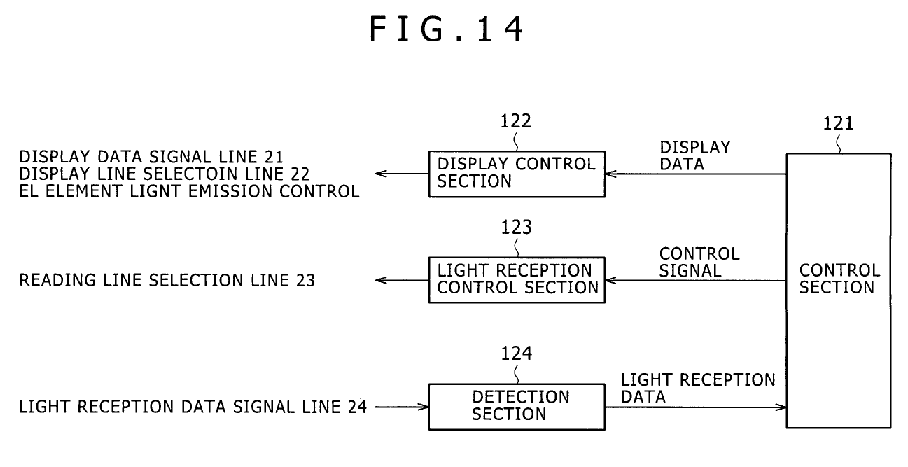

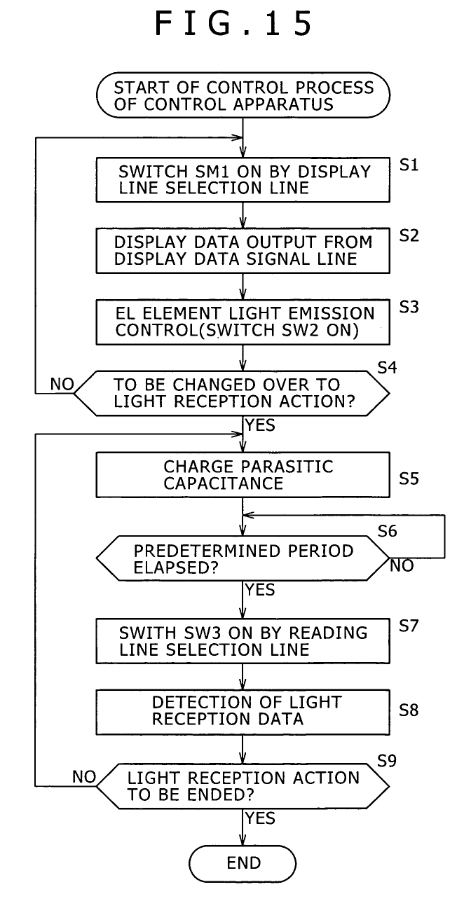

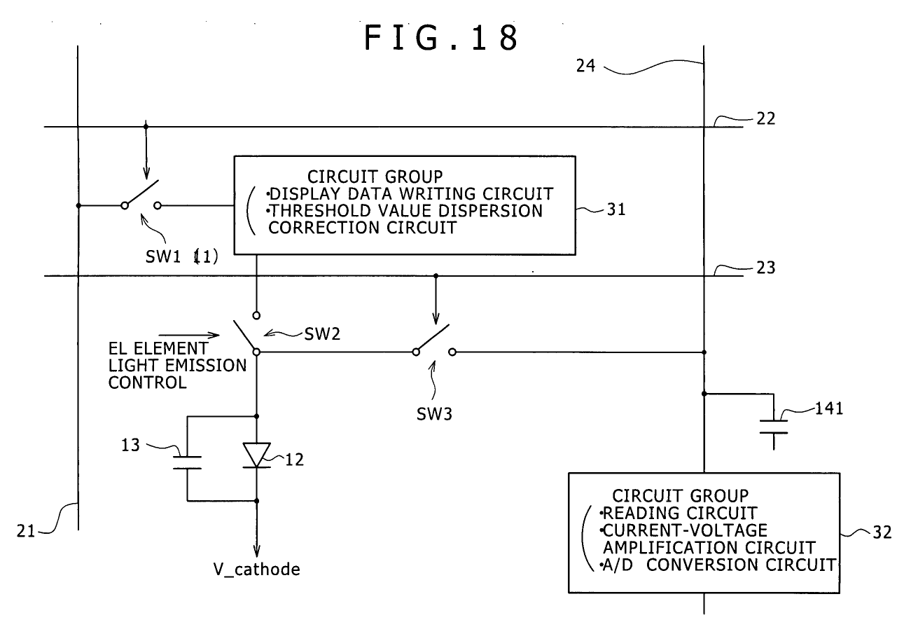

According to the invention as set forth in claim 1, a controlling apparatus (for example, a controlling apparatus 2 of FIG. 1) for controlling an inputting/outputting apparatus (for example, an I/O display apparatus 1 of FIG. 1) of the active matrix driving type which includes a pixel including an element (for example, an EL element 12 of FIG. 1) whose action can be changed over between a light emitting action and a light receiving action in response to a voltage applied to the element includes an accumulation control section (for example, a light reception control section 124 of FIG. 14 which causes a processing at step S5 of FIG. 15 to be executed) for causing charge generated by the element included in the pixel during the light receiving action in response to reception of light from the outside to be accumulated for a predetermined period of time, and a detection section (for example, a detection section 124 of FIG. 18) for detecting an input of the light from the outside to the inputting/outputting apparatus based on the charge accumulated by the accumulation control section.

According to the invention as set forth in claim 5, a controlling method for a controlling apparatus (for example, a controlling apparatus 2 of FIG. 1) for controlling an inputting/outputting apparatus (for example, an I/O display apparatus 1 of FIG. 1) of the active matrix driving type which includes a pixel including an element (for example, an EL element 12 of FIG. 1) whose action can be changed over between a light emitting action and a light receiving action in response to a voltage applied to the element includes an accumulation control step (for example, a step S5 of FIG. 15) of causing charge generated by the element included in the pixel during the light receiving action in response to reception of light from the outside to be accumulated for a predetermined period of time, and a detection step (for example, a step S8 of FIG. 15) of detecting an input of the light from the outside to the inputting/outputting apparatus based on the charge accumulated by the processing of the accumulation control section.

Also in a program recorded on a recording medium as set forth in claim 6 and a program as set forth in claim 7, an embodiment (a mere example) to which each step corresponds is similar to that in the controlling method as set forth in claim 5.

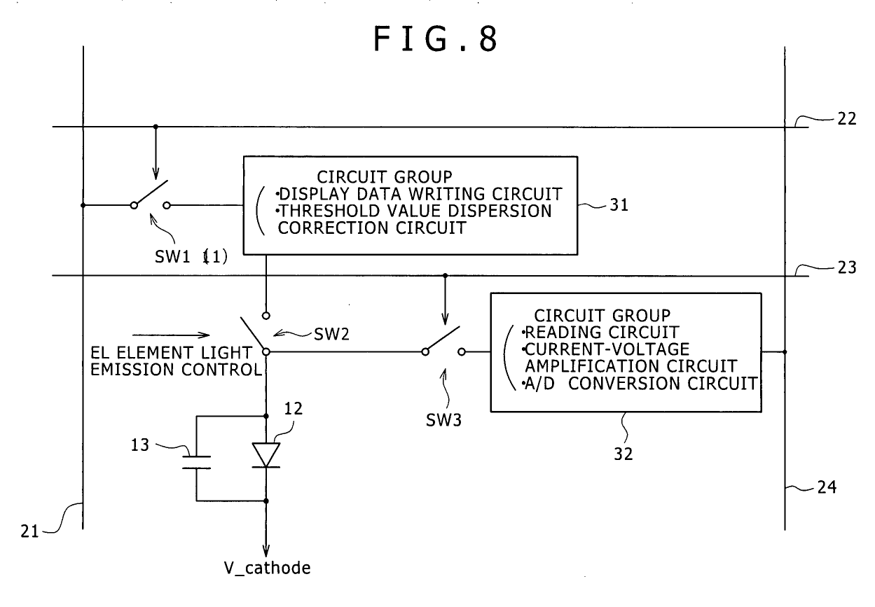

According to the invention as set forth in claim 8, an inputting/outputting apparatus (for example, an I/O display apparatus 1 of FIG. 1) of the active matrix driving type which includes a pixel including an element (for example, an EL element 12 of FIG. 1) whose action can be changed over between a light emitting action and a light receiving action in response to a voltage applied to the element, the pixel including an accumulation section (for example, a parasitic capacitor 13 of FIG. 1) for accumulating charge generated by the element included in the pixel upon the light receiving action in response to reception of light from the outside for a predetermined period of time under the control of a controlling apparatus, and an outputting section (for example, a circuit group 32 of FIG. 8) for outputting the charge accumulated in the accumulation section to the controlling apparatus.

Now, a preferred embodiment of the present invention is described in detail with reference to the accompanying drawings.

FIG. 1 shows an example of an appearance of an IN/OUT (I/O) display apparatus 1 to which the present invention is applied.

Referring to FIG. 1, the I/O display apparatus 1 shown includes pixels by which an input function (detection function) of detecting light irradiated from the outside and an output function (display function) of displaying a predetermined image can be implemented.

As shown in an enlarged scale in a circuit in FIG. 1, each of the pixels which form the I/O display apparatus 1 is represented by a switch 11 which may be, for example, a thin film transistor (TFT), an organic or inorganic EL element 12 and a parasitic capacitor 13 which is a capacitance parasitic in the EL element 12. In particular, the I/O display apparatus 1 is a self-luminous EL display apparatus which can be driven by active matrix driving.

In the I/O display apparatus 1, action of each of the pixels is controlled by a controlling apparatus 2 to implement the input function and the output function.

Here, the input function and the output function are described.

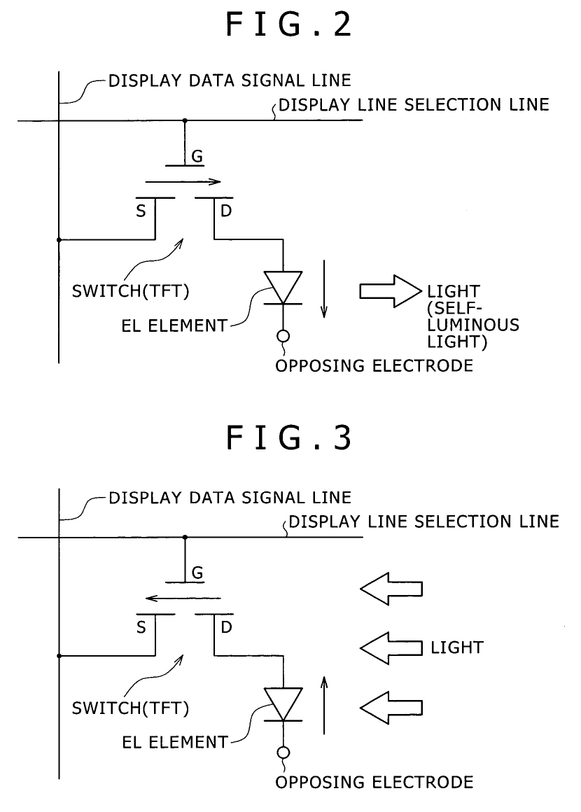

FIGS. 2 and 3 show an example of a circuit corresponding to one pixel of the I/O display apparatus 1.

When a forward voltage (bias) is applied to the gate electrode G of the TFT from a display line selection line (gate line), current flows in a direction from the source electrode S toward the drain electrode D in an active semiconductor layer (channel) made of amorphous silicon or polysilicon in response to a voltage applied to the source electrode S from a display data signal line (source line) as indicated by a solid line arrow mark in FIG. 2.

The anode electrode of the EL element is connected to the drain electrode D of the TFT, and the EL element emits light as indicated by a void arrow mark in FIG. 2 in response to a potential difference between the anode and the cathode which is caused by current flowing through the channel of the TFT.

The light from the EL element goes out to the outside of the display apparatus. Accordingly, display of an image, that is, the output function, is implemented by such action of the pixels.

On the other hand, a voltage near 0 V or a reverse voltage is applied to the gate electrode G of the TFT through the display line selection line, then even when a voltage is applied to the source electrode S through the display data signal line, no current flows in the channel, and no potential difference generates between the anode and cathode electrodes of the EL element. Consequently, no light is emitted from the pixel.

If, in this state, light from the outside is irradiated upon the pixel of FIG. 3 as indicated by void arrow marks, then the gate electrode G is opened (a channel is formed) by the photoconductivity of the channel of the TFT. Consequently, although the amount is very small, leak current (off current) flows in the direction from the drain electrode D toward the source electrode S. Further, leak current is generated in the EL element.

From this, if leak current flowing through the pixel (TFT and EL element) to which a voltage near 0 V or a reverse voltage is applied is amplified to detect whether or not such leak current exists, then it is possible to identify whether or not light is irradiated upon the pixel from the outside. Further, the amount of light can be identified depending on the amount of the leak current. Thus, the input function is achieved thereby.

For example, by irradiating light representative of predetermined data toward the display apparatus formed from such pixels as described above, the user can cause the display apparatus to detect the incoming light to the display apparatus. Consequently, data can be inputted to the display apparatus through the light.

In the following description, action of a pixel (EL element) when a forward voltage is applied as seen in FIG. 2 is referred to as light emitting action, and action of a pixel of generating leak current in response to light irradiated from the outside when a reverse voltage is applied as seen in FIG. 3 is referred to as light receiving action.

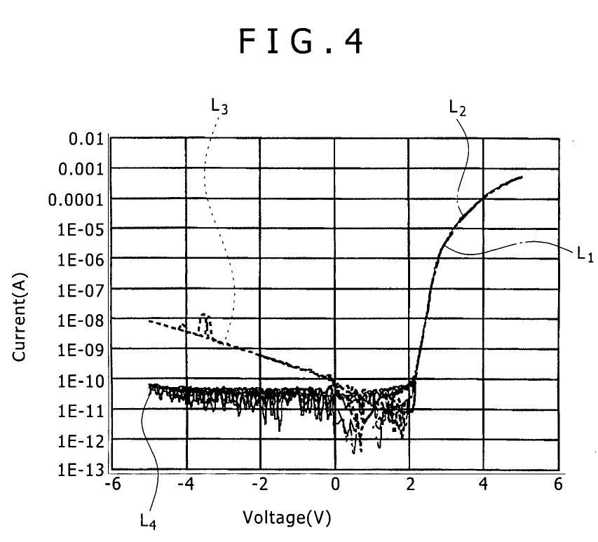

FIG. 4 illustrates a current characteristic of the pixel shown in FIGS. 2 and 3. The axis of ordinate represents the value of the current in the pixel, and the axis of abscissa represents the value of the voltage applied to the gate electrode G.

Referring to FIG. 4, a line L₁ representing a result of the measurement represents the value of current detected with the pixel when light is irradiated upon the pixel while a forward voltage is applied to the pixel, that is, the value of the sum of current flowing in the channel of the TFT and current generated by the EL element. Another line L₂ represents the value of current detected with the pixel when no light is irradiated upon the pixel while a forward voltage is applied to the pixel.

From the lines L₁ and L₂, it can be seen that, where a forward voltage is applied, no difference is found between the values of detected current irrespective of whether or not light from the outside exists.

On the other hand, a further line L₃ of FIG. 4 represents the value of current detected with the pixel when light is irradiated upon the pixel while a reverse voltage is applied to the pixel. A still further line L₄ represents the value of current detected with the pixel when no light is irradiated upon the pixel while a reverse voltage is applied to the pixel.

Where the line L₃ and the line L₄ are compared with each other, it can be recognized that, when a reverse voltage is applied to the pixel, a difference appears between the value of current detected with the pixel when light is irradiated from the outside and the value of current detected when no light is irradiated from the outside. For example, if a predetermined amount of light is irradiated upon the pixel from the outside while, for example, a voltage of approximately −5 V (reverse voltage) is applied to the pixel, then current (the sum of current flowing in the active semiconductor layer of the TFT and current generated by the EL element) of approximately “1⁻⁸ (A)” is detected.

In FIG. 4, it is indicated by the line L₄ that, even when no light is irradiated from the outside, current of a very low level of approximately “1⁻¹⁰ (A)” is generated. However, this originates from noise during the measurement. It is to be noted that measurement results similar to those of FIG. 4 are obtained irrespective of whichever one of the colors of R, G and B the light emitted from the pixel of the EL element is.

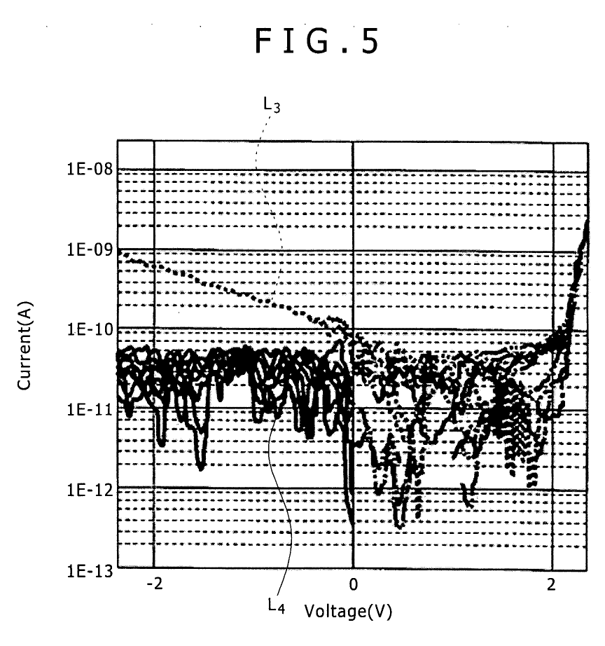

FIG. 5 shows a portion of the diagram of FIG. 4 in the proximity of 0 V.

As seen from the line L₃ and the line L₄ shown in FIG. 5, also when a voltage near 0 V is applied, a difference appears between the current value when light is irradiated and the current value when no light is irradiated.

Accordingly, even when a voltage of near 0 V is applied, the difference, that is, detection of whether or not light is irradiated, can be detected by amplifying the generated current.

From this, it is possible to cause a certain pixel to perform a light receiving action by controlling the gate voltage so as to have a value of near 0 V without positively applying a reverse voltage.

Where the gate voltage is controlled so as to have a value of near 0 V so that the pixel performs a light receiving action, the power consumption can be reduced by an amount arising from a reverse voltage when compared with the alternative case wherein a reverse voltage is applied to cause the pixel to perform a light receiving action.

Further, since the number of voltages to be controlled decreases, the control of the voltages and the system configuration are facilitated. In particular, since to control the voltage so as to have a value of near 0 V is to control so that a forward voltage may not be applied, the control can be implemented only by means of a control line and a power supply circuit for controlling the gate voltage so that a forward voltage may not be applied. In other words, a control line for controlling the gate voltage so that a reverse voltage may be applied need not be provided separately.

Consequently, the configuration of the power supply circuit on a driving circuit board or a system circuit board of the display apparatus can be simplified, and reduction in power consumption can be achieved. Also, efficient utilization of the limited space on the circuit board can be achieved.

Furthermore, by preventing application of a reverse voltage, otherwise possible breakdown of a TFT or an EL element which may occur when a reverse voltage is applied can be prevented. For example, although the voltage endurance of a TFT can be raised, for example, by increasing the channel length, in this instance, the current upon conduction decreases, and in order to assure sufficient current, it is necessary to increase the channel width (W length).

As a result, in order to raise the voltage endurance without changing the value of current flowing through a TFT, it is necessary to increase the size of the TFT. This makes it difficult to dispose such a TFT of an increased size as described above in each of pixels of a display apparatus of a high definition wherein the size of the pixels is small.

Accordingly, by eliminating the reverse voltage, design of the voltage endurance for a TFT or an EL element is facilitated and the size of the TFT or the EL element itself can be reduced. Consequently, a high definition display apparatus can be implemented.

As described above, according to the I/O display apparatus 1 wherein a TFT and an EL element are provided in each of the pixels, not only it is possible to display an image, but also it is possible to detect light from the outside using the pixels by applying a voltage of near 0 V or a reverse voltage.

Incidentally, in a display apparatus which includes pixels which can perform not only a light emitting action but also a light receiving action in this manner, the amount of leak current generated by a photoelectric effect of an EL element differs depending upon the amount (energy) of light irradiated on the pixel which is performing a light receiving action.

Accordingly, since, as the amount of irradiated light increases, the amount of generated leak current increases, the light receiving sensitivity rises. On the other hand, since as the mount of irradiated light decreases, the amount of generated leak current decreases, the light receiving sensitivity decreases.

Therefore, the I/O display apparatus 1 of FIG. 1 is configured such that, charge generated upon reception of light from the outside by a pixel which is performing a light receiving action is accumulated into a predetermined capacitor for a predetermined period of time, and the amount of the accumulated charge (amount of current) is detected collectively to raise the light receiving sensitivity.

In particular, not the amount of current generated upon reception of light is detected immediately after the current is generated to detect whether or not there is an input of light from the outside, but whether or not there is an input of light from the outside is detected based on the amount of the entire current generated within the predetermined period of time.

For the capacitor for accumulating the charge, for example, the parasitic capacitor 13 connected in parallel to the EL element 12 is used.

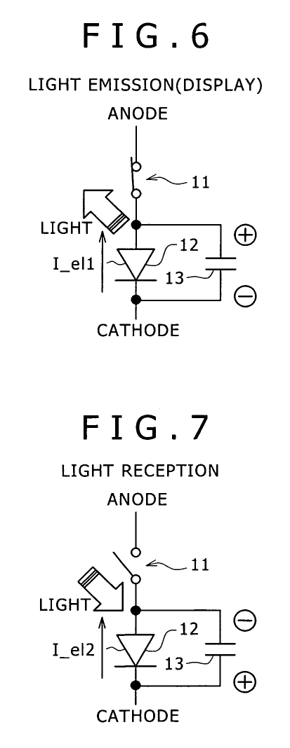

Here, operation of the circuit is described with reference to FIGS. 6 and 7.

It is assumed that, in the example shown, detection of light from the outside is performed based on leak current generated by the EL element 12. Also it is assumed that a light receiving action is performed not by positively applying a reverse bias but controlling the voltage to be applied to the switch 11 (TFT) to a value of near 0 V (to switch off the switch 11).

FIG. 6 shows an example of the circuit when it performs a light emitting action (display of an image).

If the switch 11 is switched on to apply a forward bias as seen in FIG. 6, then light emitting current I_el1 in a forward direction flows through the EL element 12, whereupon the EL element 12 emits light. At this time, positive charge is accumulated into the parasitic capacitor 13 on the anode electrode side of the EL element 12 and negative charge is accumulated into the parasitic capacitor 13 on the cathode electrode side of the EL element 12 both by an amount corresponding to the amount of the light emitting current I_el1. For example, where the amount of the light emitting current I_el1 increases and the level of light emission increases (as the luminance increases), the potential difference applied between the electrodes of the EL element 12 increases and also the amount of charge accumulated in the parasitic capacitor 13 increases.

FIG. 7 shows an example of the circuit when it performs a light receiving action.

As seen in FIG. 7, when light is irradiated upon the node from the outside while a bias near 0 V is applied (while the switch 11 is off), light receiving current I_el2 flows in the opposite direction to that of the light emitting current I_el1.

At this time, the EL element 12 does not emit light. Further, since the directions of the light emitting current I_el1 and the light receiving current I_el2 are opposite to each other, charge of the opposite polarities to those in the light emitting action is accumulated in the parasitic capacitor 13.

This state is held for a predetermined period of time. Accordingly, charge generated by the EL element 12 within the predetermined period is all accumulated into the parasitic capacitor 13.

After the predetermined period of time elapses, the input of light from the outside is detected based on the overall amount of the charge accumulated in the parasitic capacitor 13. In particular, the overall accumulated charge is extracted from a bus (not shown) connected to the parasitic capacitor 13 to detect the input.

Since an input from the outside is detected based on the entire charge generated within the predetermined period of time in this manner, the amplitude of the signal representative of the amount of the charge (that is, a signal representative of the value of current, or a signal representative of the value of a voltage obtained by converting the current value into a voltage value) can be set to an increased value, and this facilitates detection of the input performed based on the signal.

Now, a series of actions from light emission to light reception are described in connection of an example of a more particular circuit with reference to FIGS. 8 to 12.

FIG. 8 shows an example of a circuit in each of the pixels which form the I/O display apparatus 1.

Switches SW1 to SW3 are switching elements made of amorphous silicon, polysilicon or the like.

Among them, the switch SW1 (which corresponds to the switch 11 of FIG. 6) is controlled between on and off states by a display line selection line 22, and outputs, when it is in an on state, a signal supplied thereto from a display data signal line 21 and representative of display data to a circuit group 31. The signal representative of the display data is supplied, for example, from the controlling apparatus 2.

The switch SW2 is controlled between on and off states by EL element light emission control by the controlling apparatus 2 and supplies, when it is in the on state, an output of the circuit group 31 to the EL element 12.

The switch SW3 is controlled between on and off states by reading line selection line 23 and supplies, when it is in the on state, leak current (charge accumulated in the parasitic capacitor 13) generated by the EL element 12 upon reception of irradiation of light for the predetermined period of time to a circuit group 32. Thus, the switch SW3 is placed into the on state after the predetermined period of time elapses after the light receiving action is started.

The circuit group 31 includes, for example, a display data writing circuit, a threshold value dispersion correction circuit and so forth. The display data writing circuit temporarily accumulates a signal supplied thereto from the switch SW1 and performs I/V (current/voltage) conversion for causing the EL element 12 to emit light. The threshold value dispersion correction circuit is a circuit (threshold value correction circuit for the TFT) for correcting the dispersion of a signal, for example, appearing at the output of the switch SW1.

The circuit group 32 includes, for example, a reading circuit, a current-voltage amplification circuit, an A/D (Analog/Digital) conversion circuit, and so forth. The reading circuit reads out a light reception signal generated by the EL element 12 through the switch SW3. The current-voltage amplification circuit amplifies light reception current or a voltage corresponding to the light reception current. The A/D conversion circuit converts the current value or the voltage value amplified by the current-voltage amplification circuit into digital data (light reception data) and outputs the light reception data to a light reception data signal line 24. The light reception data outputted to the light reception data signal line 24 is supplied to the controlling apparatus 2 so that the input of light from the outside is detected by the controlling apparatus 2.

In FIG. 8, all of the switches SW1 to SW3 are in the off state. In this state, none of the light emitting action and the light receiving action is performed.

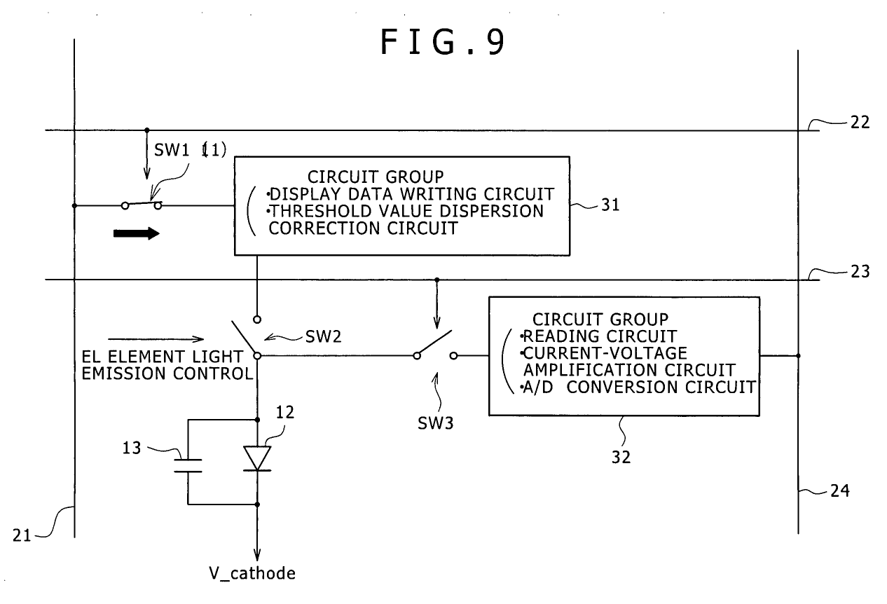

In order to cause the pixel in such a state as described above to perform a light emitting action, the switch SW1 is placed into the on state first by the display line selection line 22 as seen in FIG. 9. At this time, a signal supplied from the display data signal line 21 and representative of display data is inputted to the circuit group 31 through the switch SW1. Consequently, I/V conversion and correction of the dispersion of the signal are performed by the circuit group 31.

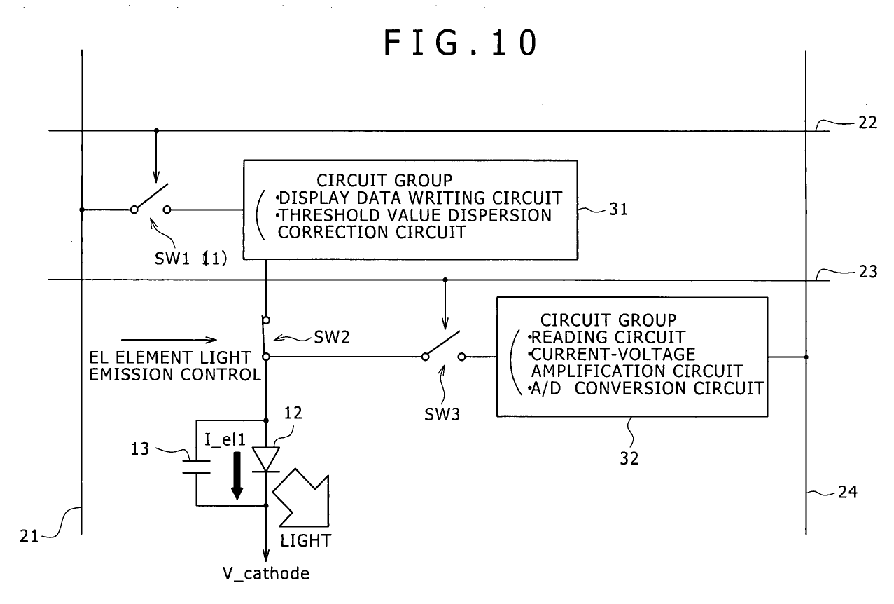

Then, after the switch SW1 is placed into the off state as seen in FIG. 10, EL element light emission control is performed by the controlling apparatus 2. Thus, since the switch SW2 is placed into the on state, light emitting current I_el1 corresponding to the display data flows from the circuit group 31 to the EL element 12. Consequently, the EL element 12 emits light with a luminance level corresponding to the display data.

At this time, a potential difference corresponding to the level of light emission, that is, a potential difference corresponding to the display data, is applied between the anode and cathode electrodes of the EL element 12, and charge corresponding to the potential difference is accumulated in the parasitic capacitor 13. The state of FIG. 10 corresponds to the state of FIG. 6.

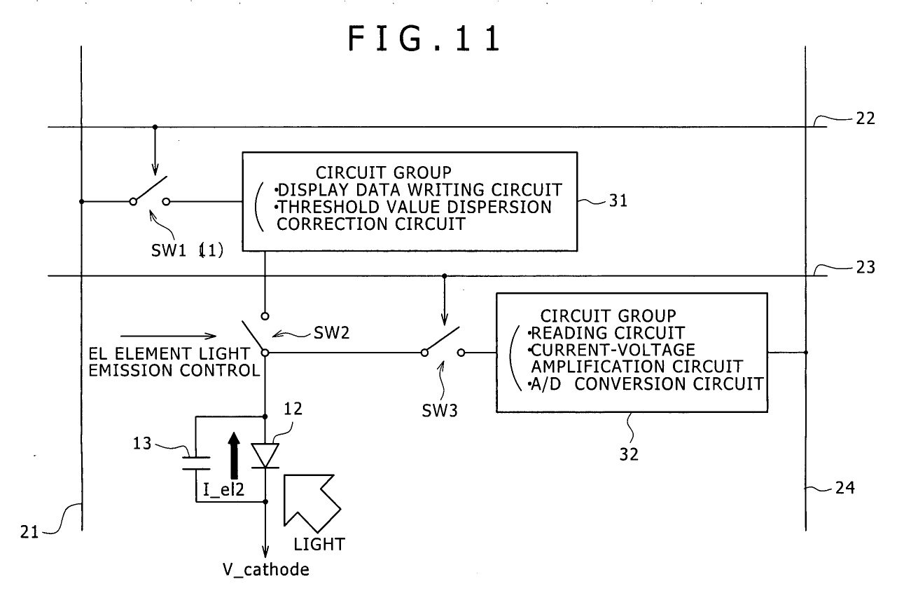

Then, in order to change over the action of the pixel from the light emitting action to the light receiving action, the switch SW2 is placed into the off state as seen in FIG. 11 and this state is kept for the predetermined period of time. Charge (light receiving current I_el2) generated by the EL element 12 upon reception of the light from the outside is accumulated into the parasitic capacitor 13. In the example of FIG. 11, since the impedance of the cathode electrode side of the EL element 12 is lower than that of the anode electrode side of the EL element 12, the charge on the cathode electrode side of the parasitic capacitor 13 escapes. However, since a path for discharging the charge is not provided for the anode electrode side, negative charge remains accumulated. The state of FIG. 11 corresponds to the state of FIG. 7.

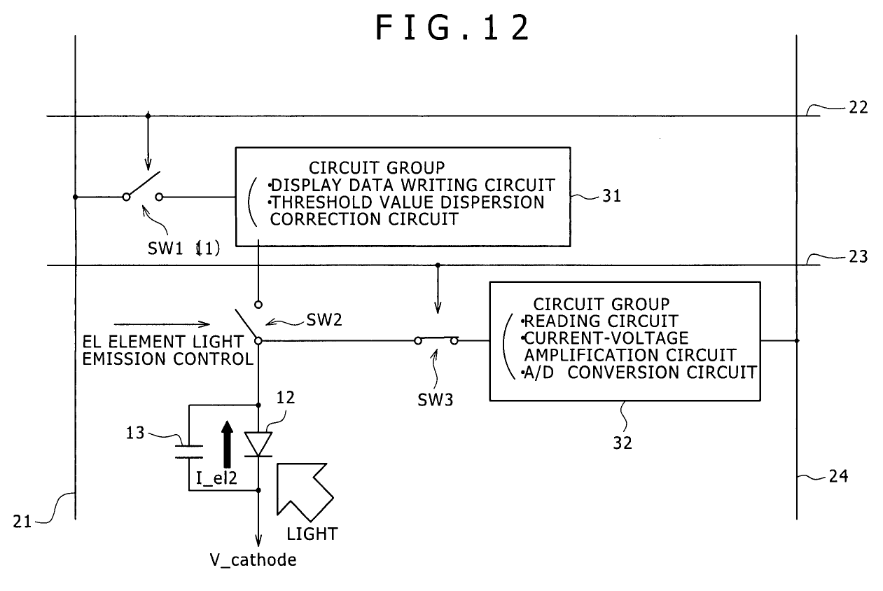

After the state of FIG. 11 is kept for the predetermined period of time, the switch SW3 is placed into the on state by the reading line selection line 23 as seen in FIG. 12. Consequently, current corresponding to the amount of charge accumulated in the parasitic capacitor 13 is supplied to the circuit group 32 through the switch SW3. Also light receiving current I_el2 generated by the EL element 12 while the switch SW3 keeps the on state is supplied to the circuit group 32.

The circuit group 32 performs predetermined processing such as amplification for the signal supplied thereto and outputs resulting light reception data to the controlling apparatus 2 through the light reception data signal line 24.

By the series of actions described above, detection of an input from the outside is performed based on the overall amount of charge accumulated in the parasitic capacitor 13. The processing of the controlling apparatus 2 which controls the actions of the pixels in this manner is hereinafter described.

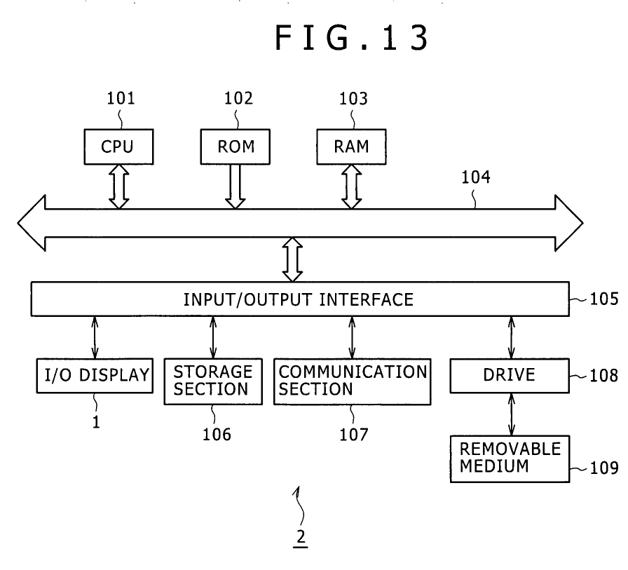

FIG. 13 shows an example of a configuration of the controlling apparatus 2.

Referring to FIG. 13, a central processing unit (CPU) 101 executes various processing based on a program stored in a ROM (Read Only Memory) 102 or a program loaded into a RAM (Random Access Memory) 103 from a storage section 106. Also data and so forth necessary for the CPU 101 to execute the various processing are suitably stored into the RAM 103.

The CPU 101, ROM 102 and RAM 103 are connected to each other by a bus 104. Also an input/output interface 105 is connected to the bus 104.

The storage section 106, which is formed from a hard disk, a communication section 107 which performs a communication processing through a network and so forth are connected to the input/output interface 105 in addition to the I/O display apparatus 1.

When necessary, a drive 108 is connected to the input/output interface 105, and a removable medium 109 which may be a magnetic disk, an optical disk, a magneto-optical disk or a semiconductor memory is loaded suitably into the drive 108 such that a computer program read out from the removable medium 109 is installed into the storage section 106 as occasion demands.

FIG. 14 shows an example of a functional configuration of the controlling apparatus 2.

At least part of the configuration shown in FIG. 14 is implemented by a predetermined program executed by the CPU 101 of FIG. 13.

A control section 121 outputs, for example, acquired display data to a display control section 122 so that the display data is displayed using the pixels of the I/O display apparatus 1 which perform the light emitting action (to cause each of the pixels to emit light with a level corresponding to the display data).

Further, the control section 121 controls a light reception control section 123 to cause predetermined ones of the pixels of the I/O display apparatus 1 to perform the light receiving action. The control section 121 performs, when light reception data is supplied thereto from a detection section 124, a predetermined processing based on the received light reception data.

The display control section 122 selects a line of those pixels which are to perform the light emitting action from among the display line selection lines 22 based on the display data supplied thereto from the control section 121 and supplies signals representative of the display data to the selected lines from the display data signal lines 21 to cause the pixels of the selected line to perform the light emitting action. Further, the display control section 122 performs EL element light emission control at a predetermined time to place the switch SW2 into the on state.

The light reception control section 123 selects, under the control of the control section 121, a line of those pixels which are to perform the light receiving action through the reading line selection line 23 and places the switches SW3 into the on state after the predetermined period of time elapses after the light receiving action is started.

The detection section 124 detects data inputted from the outside using light based on the light reception data supplied thereto through the light reception data signal line 24 and outputs the detected light reception data to the control section 121.

Now, a controlling processing of the I/O display apparatus 1 performed by the controlling apparatus 2 having the configuration described above is described with reference to the flow chart of FIG. 15. This processing is started when display data are supplied from the control section 121 to the display control section 122 when the I/O display apparatus 1 is in such a state as seen in FIG. 8.

At step S1, the display control section 122 selects a line of those pixels which are to perform the light emitting action through the display line selection line 22 based on the display data supplied thereto from the control section 121 and places the switches SW1 of the pixels of the selected line into the on state (FIG. 9).

Further, the display control section 122 supplies signals representative of the display data to the pixels which are to perform the light emitting action through the respective display data signal lines 21 at step S2. Then at step S3, the display control section 122 performs EL element light emission control. Consequently, each of the switches SW2 is placed into the on state, and light emitting current I_el1 obtained by the predetermined processing performed by the circuit group 31 flows through the EL element 12 to cause the EL element 12 to emit light (FIG. 10).

It is to be noted that the display control section 122 performs further control to place the switch SW1 into the off state before the EL element light emission control is performed and to place the switch SW2 into the off state after the EL element 12 emits light.

The display control section 122 decides, at step S4, whether or not the action of the pixel having performed the light emitting action should be changed over to the light receiving action. If it is decided that the action of the pixel should not be changed over, then the processing returns to step S1 to repeat the series of processing described above.

If it is decided at step S4 by the display control section 122 that the action of the pixel having performed the light emitting action should be changed over to the light receiving action, then the processing advances to step S5.

At step S5, the off state of the switch SW2 is maintained so that charge generated by the EL element 12 in response to reception of light remains accumulated into the parasitic capacitor 13 (FIG. 11).

At step S6, the light reception control section 123 decides whether or not the predetermined period of time elapses after the switch SW2 of the pixel which is performing the light receiving action is placed into the off state. Thus, the light reception control section 123 stands by until after it is decided that the predetermined period of time elapses.

If the light reception control section 123 decides at step S6 that the predetermined period of time elapses after the switch SW2 is placed into the off state, then the processing advances to step S7. At step S87, the light reception control section 123 places the switch SW3 of the pixel having performed the light receiving action into the on state so that a signal corresponding to the charge generated by the EL element 12 and accumulated in the parasitic capacitor 13 is supplied to the circuit group 32.

The predetermined processing such as amplification are performed for the light receiving current I_el2 supplied to the circuit group 32, and resulting light reception data is supplied to the detection section 124 of the controlling apparatus 2 through the light reception data signal line 24.

At step S8, the detection section 124 detects the light reception data supplied thereto through the light reception data signal line 24 and outputs the detected light reception data to the control section 121.

At step S9, the light reception control section 123 decides whether or not the light receiving action should be ended. If it is decided that the light receiving action should not be ended, then the light reception control section 123 places the switch SW3 into the off state. Thereafter, the processing returns to step S5 so that the processing at the steps beginning with step s5 are repeated. If the light reception control section 123 decides at step S9 that the light receiving action should be ended, then it ends the processing.

Each of the pixels can perform display of an image and detection of light by causing the pixel to repetitively execute the series of processing described above.

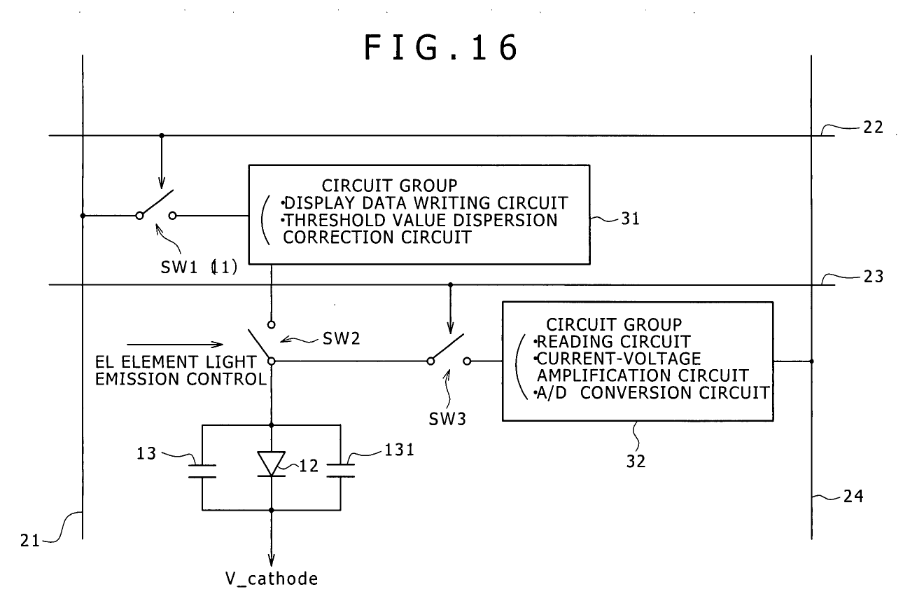

In the description above, it is described that the parasitic capacitor 13 is used as an element for accumulating charge generated by the EL element 12, a capacitor 131 different from the capacitance parasitic to the EL element 12 may be provided in parallel to the EL element 12 as seen in FIG. 16.

In this instance, charge generated by the EL element 12 can be accumulated into the capacitor 131 by an arbitrary amount which does not rely upon the parasitic capacitor 13.

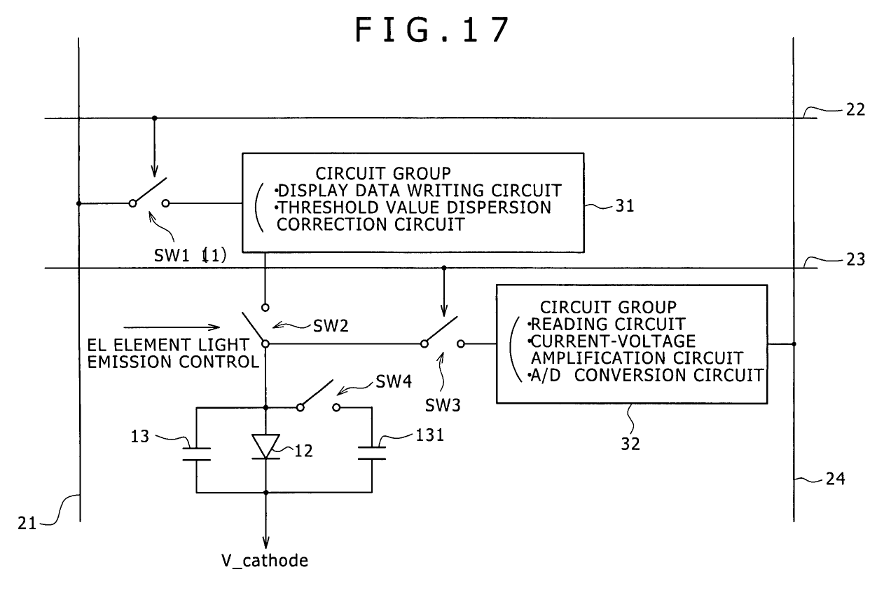

Further, a switch SW4 may be interposed between the anode electrode of the EL element 12 and the capacitor 131 as seen in FIG. 17 such that it can be changed over between a state wherein the capacitor 131 is connected in parallel to the EL element 12 and another state wherein the capacitor 131 is not connected in parallel to the EL element 12.

The switch SW4 is placed into the on state when the EL element 12 is to perform the light receiving action, but is placed into the off state when the I/O display apparatus 1 is to perform the light emitting action (when the light emitting action is started). The capacitor 131 connected in parallel to the EL element 12 acts as an element for increasing the time constant in the light emitting action, and where the capacitor 131 is normally connected to the EL element 12, it acts to deteriorate the responsibility of light emission. Therefore, the capacitor 131 can be disconnected from the EL element 12 in the light emitting action in this manner so that deterioration of the responsiveness in light emission can be prevented.

In this manner, the capacitor 131 which is a capacitor for accumulating charge generated by the EL element 12 is not limited to that which is provided in each pixel but may be provided outside the pixels such that it is connected to the reading line selection line 23. In the example of FIG. 18, the switches SW1, SW2 and SW3, EL element 12, parasitic capacitor 13 and circuit group 31 are provided in the inside of each pixel, and a capacitor 141 is provided outside the pixel (outside the range surrounded by the gate line (display line selection line 22) and the source line (display data signal line 21)).

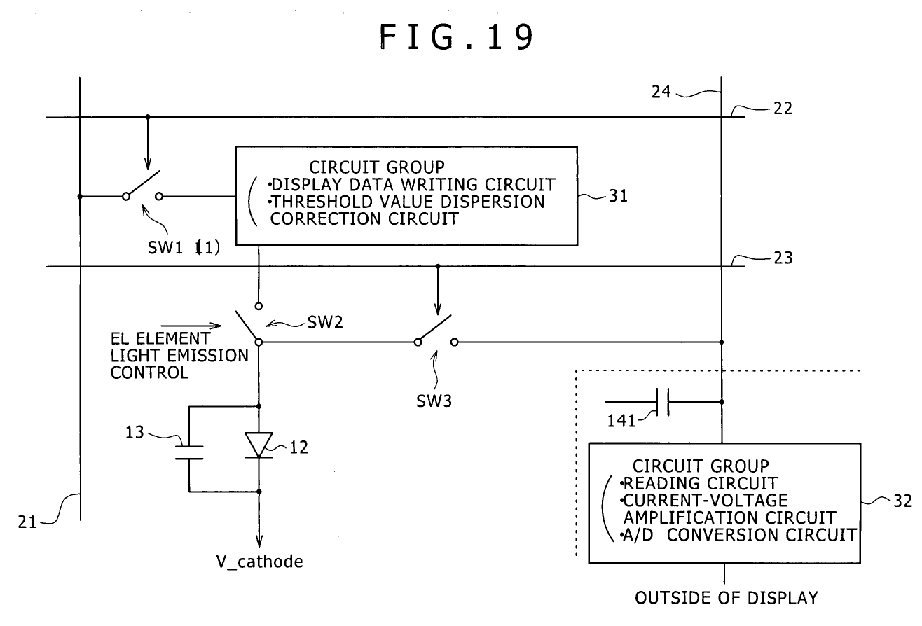

FIG. 19 shows an example wherein a capacitor 141 which is a capacitor for accumulating charge generated by the EL element 12 is provided outside a display unit. Here, the display unit signifies a display surface formed from a plurality of pixels disposed thereon and each including the switches SW1, SW2 and SW3, EL element 12, parasitic capacitor 13 and circuit group 31, and in the example of FIG. 19, the capacitor 141 and the circuit group 32 are provided outside the display surface.

In particular, the capacitor 141 can be provided at any various positions outside the pixels or outside the display unit as seen in FIG. 18 or 19 only if charge generated by the EL element 12 can be accumulated at the position.

While it is described in the foregoing description that the controlling apparatus 2 is built in the I/O display apparatus 1 as seen in FIG. 1, naturally it may otherwise be provided outside the I/O display apparatus 1.

While the series of processing described above can be executed by hardware, it may otherwise be executed by software.

Where the series of processing is executed by software, a program which constructs the software is installed from a network or a recording medium into a computer incorporated in hardware for exclusive use or, for example, a personal computer for universal use which can execute various functions by installing various programs.

The recording medium may be formed as the removable medium 109 such as, as shown in FIG. 13, a magnetic disk (including a floppy disk), an optical disk (including a CD-ROM (Compact Disc-Read Only Memory) and a DVD (Digital Versatile Disk)), a magneto-optical disk (including an MD (trademark) (Mini-Disc)), or a semiconductor memory which has the program recorded thereon or therein and is distributed in order to provide the program to a user separately from an apparatus body, or as the ROM 102 having the program recorded therein or thereon or a hard disk included in the storage section 106 which is provided to a user in a form wherein it is incorporated in an apparatus body in advance.

It is to be noted that, in the present specification, the steps may be but need not necessarily be processed in a time series in the order as described, and include processing which are executed parallelly or individually without being processed in a time series.

While a preferred embodiment of the present invention has been described using specific terms, such description is for illustrative purpose only, and it is to be understood that changes and variations may be made without departing from the spirit or scope of the following claims.

1. A controlling apparatus for controlling an inputting/outputting apparatus of an active matrix driving type that includes a pixel including an element whose action can be changed over between a light emitting action and a light receiving action in response to a voltage applied to the element, the controlling apparatus comprising:
an accumulation control section for causing a charge, generated by the element included in the pixel during the light receiving action in response to reception of light from the outside, to be accumulated for a predetermined period of time; and
a detection section for detecting an input of the light from the outside to said inputting/outputting apparatus based on the charge accumulated by said accumulation control section.

2. The controlling apparatus according to claim 1, wherein said element is an electroluminescence element, and said accumulation control section causes the charge generated by the element to be accumulated into a parasitic capacitance of the electroluminescence element.

3. The controlling apparatus according to claim 1, wherein said accumulation control section causes the charge generated by the element to be accumulated into a capacitor provided in the pixel.

4. The controlling apparatus according to claim 1, wherein said accumulation control section causes the charge generated by the element to be accumulated into a capacitor provided outside the pixel that includes the element.

5. A controlling method for a controlling apparatus controlling an inputting/outputting apparatus of the active matrix driving type that includes a pixel including an element whose action can be changed over between a light emitting action and a light receiving action in response to a voltage applied to the element, the method comprising the steps of:
controlling accumulation of a charge generated by the element included in the pixel during the light receiving action in response to reception of light from the outside for a predetermined period of time; and
detecting an input of the light from the outside to said inputting/outputting apparatus based on the charge accumulated by the controlling accumulation step.

6. A recording medium on which a program for causing a computer to execute a controlling processing for a controlling apparatus for an inputting/outputting apparatus of the active matrix driving type that includes a pixel including an element whose action can be changed over between a light emitting action and a light receiving action in response to a voltage applied to the element is recorded, the program comprising the steps of:
controlling accumulation of a charge generated by the element included in the pixel during the light receiving action in response to reception of light from the outside for a predetermined period of time; and
controlling detection of an input of the light from the outside to said inputting/outputting apparatus based on the charge accumulated by the controlling accumulation step.

7. A program for causing a computer to execute a controlling processing for a controlling apparatus for an inputting/outputting apparatus of the active matrix driving type that includes a pixel including an element whose action can be changed over between a light emitting action and a light receiving action in response to a voltage applied to the element is recorded, the program comprising the steps of:
controlling accumulation of a charge generated by the element included in the pixel during the light receiving action in response to reception of light from the outside for a predetermined period of time; and
controlling detection of an input of the light from the outside to said inputting/outputting apparatus based on the charge accumulated by the controlling accumulation step.

8. An inputting/outputting apparatus of the active matrix driving type that includes a pixel including an element whose action can be changed over between a light emitting action and a light receiving action in response to a voltage applied to the element, said pixel comprising:
an accumulation section for accumulating charge generated by the element included in the pixel upon the light receiving action in response to reception of light from the outside for a predetermined period of time under control of a controlling apparatus; and
an outputting section for outputting the charge accumulated in said accumulation section to said controlling apparatus.
